(19) United States
(12) Patent Application Publication
(10) Pub. No.: US 2009/0261607 A1
(43) Pub. Date: Oct. 22, 2009

(54) BLOCKING TOOL

(76) Inventor: Justin Braver, Pittsburgh, PA (US)

Correspondence Address: COHEN & GRIGSBY, P.C., 625 LIBERTY AVENUE, PITTSBURGH, PA, 15222-3152, US

(21) Appl. No.: 12/104,707

(22) Filed: Apr. 17, 2008

(51) Int. Cl. B65G 7/12

(52) U.S. Cl. 294/26; 294/19.1

(57) ABSTRACT

A device is provided for aligning objects. The device includes an elongated body having a grabbing end that forms an arm extending from the body and terminates with a short nub, and a grip end that forms a loop with at least one curvature and a protrusion located generally intermediate the arm and the loop.

### BACKGROUND OF THE INVENTION

Many retail stores display merchandise on shelves arranged to present customers with a neat, well stocked selection of items. Typically stores such as grocery stores, drugstores and the like align merchandise in rows starting at the front of a shelf with items stacked one behind the other. As customers take items, the retailer moves items from the back to the front of the shelf, which, in the industry, is referred to as blocking and/or facing.

Blocking can be time consuming and tedious depending on the particular item. Sometimes it can be very difficult for a retailer to get a hand behind the item in the rear and move it forward. One solution to this problem is addressed by self adjusting shelves, presently on the market, which have spring bias to maintain the items at the front of the row. Normally these spring bias shelves are limited in use to various medicines and vitamins. Also, there are slanted shelves on the market that feed the item forward by gravity. These spring-bias and slanted shelves are not only expensive but also generally limited to a given size or shape of the item or container.

Also prior systems have the disadvantage that they are prone to breaking and jamming, and can be costly to implement through a merchandising set.

### SUMMARY OF THE INVENTION

In various embodiments, the present invention is directed to a device for manually blocking items sorted on shelves or display areas. In embodiments, the device provides an elongated body having a grabbing end and a grip end. The grip end enables a user to manipulate the device and use the grabbing end to grab, move and/or align items into a desired arrangement. In examples, the device further includes a protrusion for temporarily storing the device.

Other embodiments, features, aspects and advantages of the present invention will become better understood or apparent from the following detailed description, drawings, and appended claims of the invention.

### BRIEF DESCRIPTION OF THE DRAWINGS

The accompanying drawings illustrate examples of embodiments of the invention. In such drawings:

FIG. 1 illustrates a perspective view of a device according to example of present invention.

FIG. 2 illustrates a side view of a device according to example of present invention.

FIG. 3 illustrates a top view of the device as seen along lines A-A of FIG. 1.

FIGS. 4-12 illustrate fragmentary views of embodiments of the grabbing end of the device according to examples of present invention.

FIG. 13 illustrates a view of an embodiment of the grabbing end of the device according to an example of present invention with a cap.

FIGS. 14-20 illustrate enlarged fragmentary views of embodiments of the grip portion of the device according to example of present invention.

FIGS. 21-23 illustrate views of embodiments of the grip portion of the device according to examples of present invention having an optional insert.

### DESCRIPTION

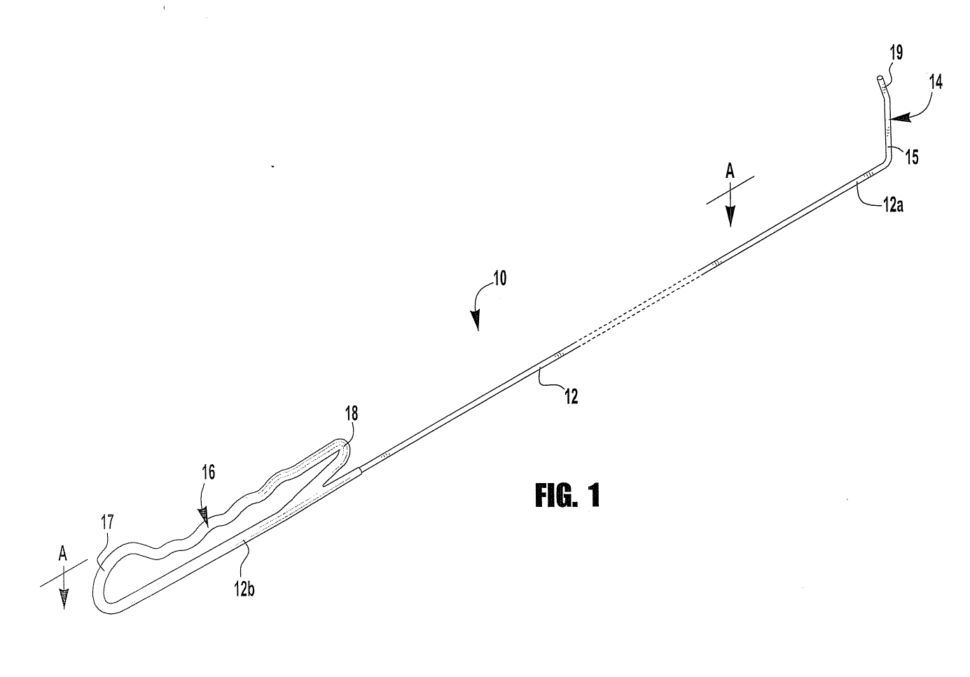

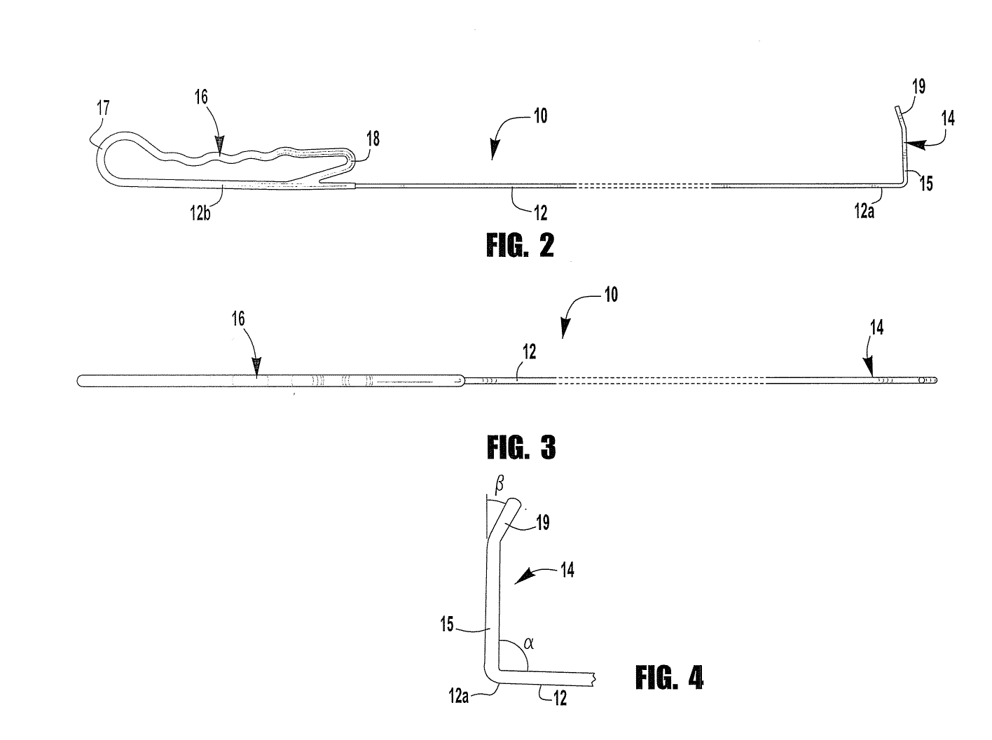

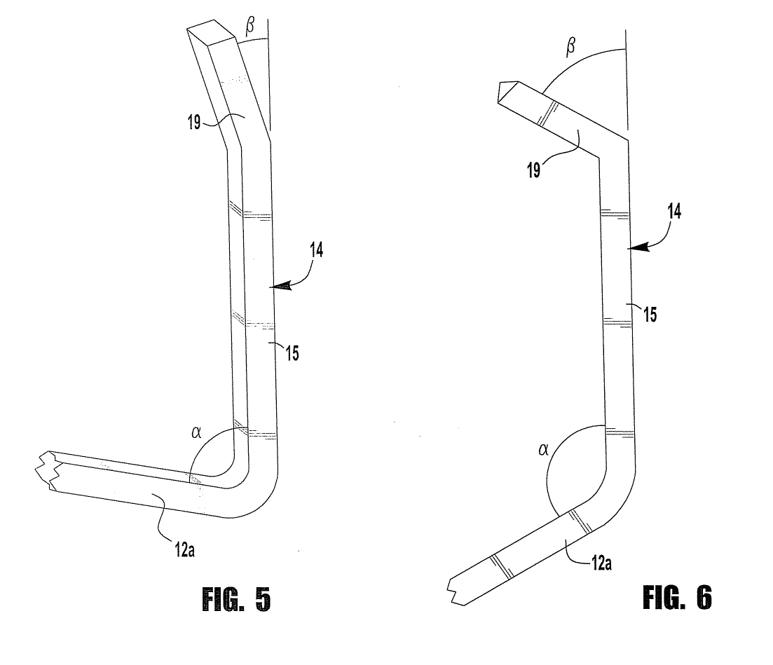

In general, aspects of the invention are shown as device 10 illustrated in FIGS. 1-3. Device 10 has the general form of an elongated body 12. A grabbing end 14 is provided on one end 12a of the body 12, and a grip portion 16 is formed on the opposite end 12b of the body 12. The body 12 may be made of metal, plastic or any other material suitable for pulling the weight of the objects with which the device would be used. For instance, the body 12 can comprise an elongated rod made of a thick metallic wire, or other suitable materials, such as plastic or composites, or aluminum or various metallic and non-metallic alloys. The type of material from which the blocking tool 10 is made is not critical provided it has a sufficient durability to manage the weight of the object or objects with which tool 10 would be used. The body 12 may have a shape that is tubular, triangular, or squared, for example, or it may be unsymetric shape. In examples, the body 12 employs a flat surface. It is squared off as in FIG. 5 or triangular as in FIG. 6. The flat side can be used for holding tool 10 in place during the blocking/facing procedure.

More particularly in an embodiment the grabbing end 14 of the blocking tool 10 is integral with the elongated rod 12. The grabbing end 14 is in the form of one end 12a of the rod 12 being bent at an angle relative to the horizontal (along the axis A as shown in FIG. 1) and extending upwardly therefrom a short distance forming an arm 15. A short nub 19 is formed at an incline extending from the arm 15 creating a terminal end of the grabbing end 14. The short nub 19 is inclined at an acute angle, relative to a vertical plane that passes though the arm 15, upwardly and then inwardly and backwardly toward the opposite end 12b of the elongated rod 12 that forms the grip portion 16. The nub 19 in cooperation with the arm 15 forms a concave collecting surface that when placed adjacent to an item (not shown) forces the item toward the straight portion of the rod 12 and grabs the item in such position as the blocking tool 10 is used in the blocking/facing operation. The tool can be designed so that the collecting surface is sized for use with one or multiple items.

In an example of grabbing end 14, such as shown in FIG. 4, the arm 15 extends at an angle α from the one end 12a of the rod 12. Angle α measures in the range from about 45° to about 100°; more particularly angle α is about 80° to 95°. For an example, angle α is approximately ninety degrees.

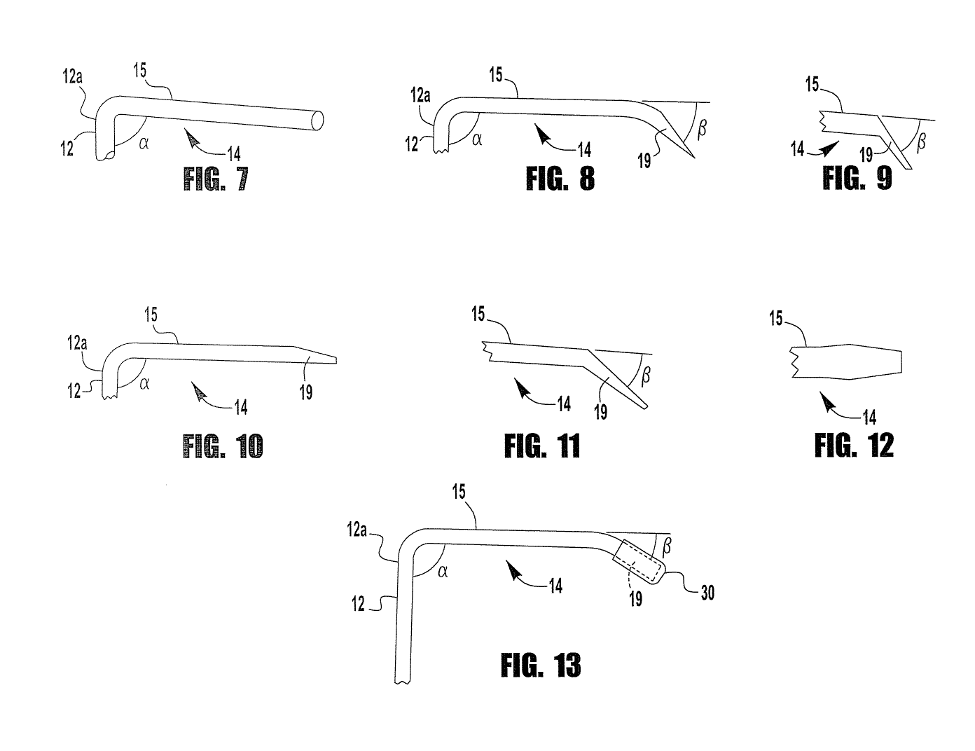

The nub 19 is disposed at the end of arm 15 providing an end to grabbing arm. In examples, nub 19 is positioned at an angle β from arm 15. Angle β can be zero to about 60°, and is generally in the range of about 10° to about 60°, and, more particularly, is in the range of about 35° to about 55°. In an example, β is about 45°. In at least two examples, such as shown in FIGS. 7 and 10, angle β is zero.

In addition to the variations in positioning, the shape of nub 19 also varies. In examples, it is consistent with that of arm 15. In examples, nub 16 terminates with an end that may be flat, tapered, pointed or beveled. Various embodiments showing the forms of the nub 19 are illustrated in FIGS. 5-12, for examples. According to aspects of the invention, the nub 19 is approximately one-third the elongated length of the arm 15. For example, the arm 15 has a length in the range of about 3 cm to about 12 cm, and the nub 19 has a length in the range of about 1 cm to 4 cm. In another example, the arm 15 has a length in the range of about 3 cm to about 6 cm, and the nub 19 has a length in the range of about cm to about 3 cm. Measurements of grabbing portion 14 can be adapted to accommodate the dimensions of the items with which the tool 10 will be used. In an example, device 10 is used for aligning items on conventional flat shelves.

Tests were run to determine the ranges for angles α and β. The tools 10 used in the tests were of the construction illustrated in FIG. 1 and made of a metal rod 12 and grabbing arm 14. In a specific example, arm 15 was about 4.5 cm long and nub 19 was about 1.5 cm long. Angle α was about 90° with some tests run at variations of 5° plus or minus. Angle α was also tested at about 80° and 120° and ranges therein with variations in angle β. Angle β was tested at 0° to about 65°. Device 10 having these proportions performed well except when angle β exceeded about 60° the functionality became more limited. They would be generally expected to function effectively with cans, bottles and jars typically found in grocery or drugstores. Tests were not conducted with angle β in about the 65°-90° range but it is contemplated they would function to some degree with the tools that were tested. Additionally, the functionality of the tool is somewhat dependent upon the selected angles α and β both of which may be altered to accommodate particular situation. It is not known whether angle α greater than 120° would provide comparable performance as the ones used. That determination can be made by persons skilled in the art.

Referring to another example in FIG. 13, the nub 19 may be provided with a cap 30. The cap 30 is shaped to the contour of the perimeter of the nub 19 and includes a hollow end that allows the cap 30 to fit over the end of the nub 19. In an example the cap 30 is cylindrical. The cap 30 may be manufactured of a resilient material such as rubber and/or plastic. It should be understood that other materials may be utilized in the construction of the cap 30.

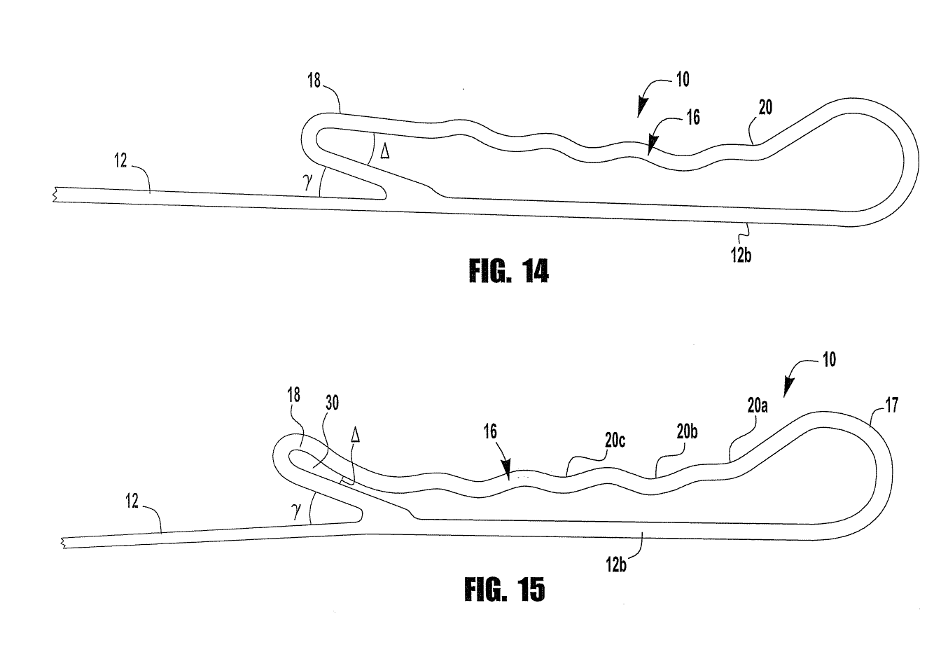

The grip portion 16 formed on the opposite end 12b of the rod 12 has the general shape of an asymmetric loop 17 coupled with a protrusion 18. The asymmetric loop 17 is in the form of the opposite end 12b of the rod 12 being bent upwardly, outwardly and then backwardly toward and in generally the same vertical plane as the grabbing end 14, as illustrated in FIG. 14 for example. In various embodiments, the backward bend of loop 17 has at least one curved undulation 20. In an example, such as the tool 10 of FIG. 15, loop 17 has a somewhat race-track configuration comprising of multiple undulations, 20a, 20b, 20c, . . . 20n. Undulations 20 may be formed directly in the loop 17 itself such as by bending or molding the grip 16 of the rod 12. In embodiments, the multiple undulations 20a-20c accommodate a user's fingers having the shape of a finger grip along loop 17 for better control and manipulation of the blocking tool 10 during operation. In an example undulations 20 can be formed on the outer surface of a portion of the loop 17 from a separate piece of material that is suitable to attach to the rod (not shown). Through experimentation, it has been found that a series of shaped undulations 20a-20c is also beneficial in comfort for grasping and manipulation of the blocking tool 10. It should be understood that the exact design, shape and configuration of the undulations is not limiting to the principles of the present invention and other shapes and designs and modifications can be utilized.

Furthermore, configuration of the grip portion 16 is not so limited to the specific shape and configuration or dimension shown but can be varied and modified as to the desired need. For example, additional undulations could be added, bringing the total number of undulations to four to account for the four fingers of an operator's hand. Such additional undulations could make it easier for an operator to grasp the tool 10. Still further, the spacing distance between the rod ends 12b and loop/protrusion portion, such as two wire rod portions that comprise the grip portion 16, could be expanded to increase the width dimension. In examples, the width is somewhat greater than that shown so as to more-or-less conform to the normal size hand grip of an operator.

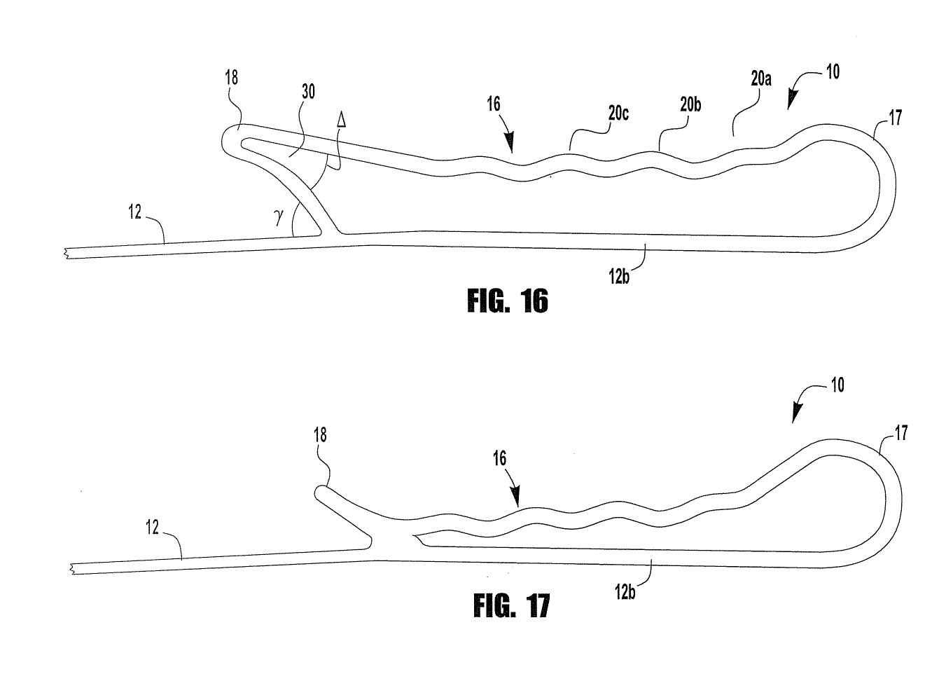

The protrusion 18 extends from the rod 12 at an acute angle γ intermediate the grabbing end 14 and the grip portion 16 generally in the direction of the grabbing end 14. Angle γ measures about 20° to about 80°. In examples such as shown in embodiments of FIGS. 14-16, the protrusion 18 is continuous with loop 17. As such, loop 17 and protrusion 18 may be integrally formed from a continuous part of grip portion 16.

The protrusion 18 in these embodiments bends about to leave space for an opening 30 integral with that of the loop 17. The opening 30 can be expanded or compressed along distance γ as is illustrated, respectively, for examples in FIGS. 14 and 15. The opening 30 is not essential. Absent opening 30, such as shown in FIG. 17, grip portion 16 provides a more narrow protrusion. In an embodiment, the handle has an exposed wire-end protrusion, where the wire joins the neck 12 (via tack-weld, for example) to close the handle formation of grip portion 16. In an example of the embodiment of FIG. 17, protrusion 18 continues for about 2-3 cm, positioned at about a 45° angle γ from the neck 12, and terminates as an exposed wire end. This provides a crude, simplistic design that can be a more cost effective way to incorporate the “hanging/gripping nub” feature into the tool 10. In examples protrusion 18 offers a hanging feature in that one can use it to hang the tool 10 (e.g., from the side of a shopping cart, one's pocket or belt, the lip of the shelf, etc.).

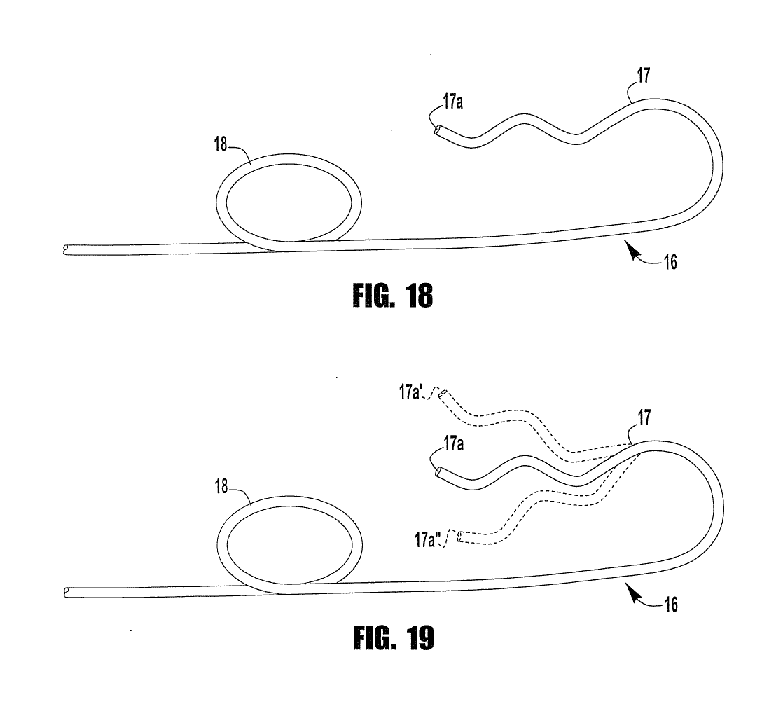

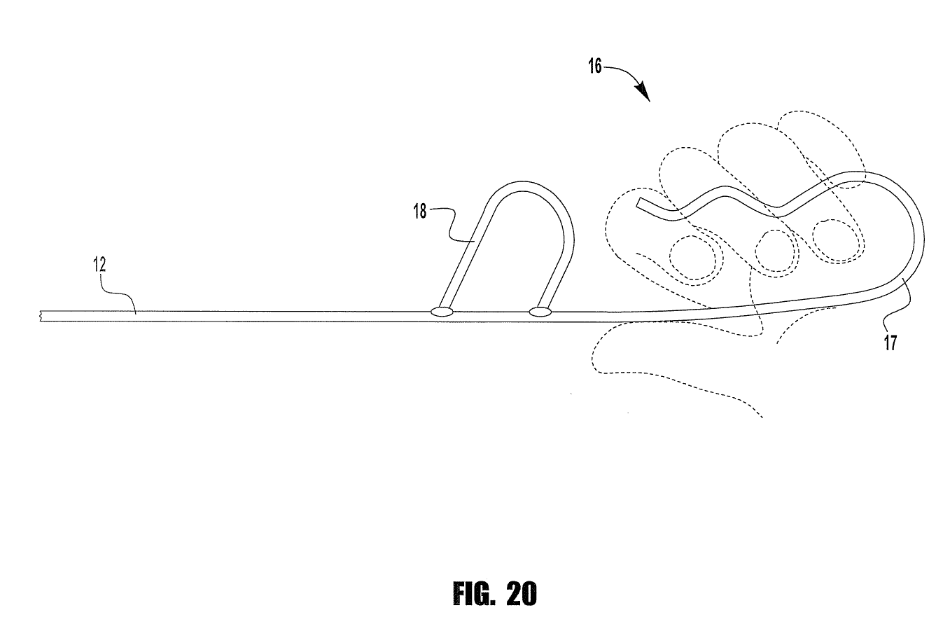

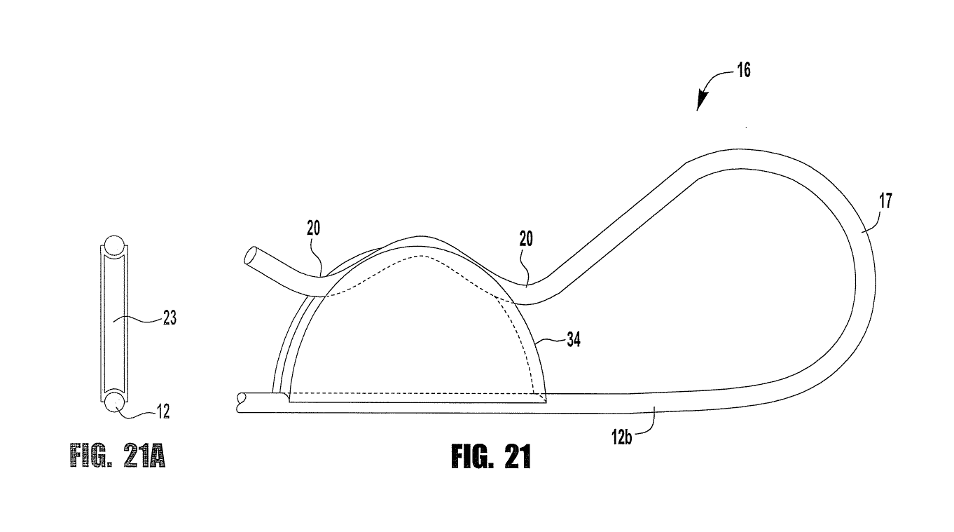

Alternatively, in embodiments as shown for example in FIGS. 18-20, protrusion 18 and loop 17 are not continuous, and the loop 17 terminates with hook 17a positioned relatively close to the protrusion 18. The hook 17a can be used for multiple purposes, such as, hanging the tool 10 on the side of a shopping cart, on a shelf, on a belt loop or pocket. As illustrated in dotted line form in FIG. 19, hook 17a′ can be pliable or bendable such that it can be expanded outwardly to a more open mode 17a′ or contracted inwardly to a more closed mode 17a″. Also, preferably but not required, the grip portion 16 of the blocking tool 12 has a rubberized coating so as to provide a comfortable grip and protection to the skin and clothing of the operator.

In use, in an example the operator grabs the tool 10 by the grip portion 16 and rotates it about ninety degrees upwardly so that the grabbing arm 15 is positioned upright. The operator then slides the tool 10 rearwardly between rows of items to the rearmost item, rotates the tool 10 in the opposite direction ninety degrees so that the grabbing portion 14 extends horizontally behind the last item. The user pulls the tool 10 forward which drags the last item, along with any items in-front thereof, forwardly so that the front item is at the front of the shelf. Additionally, the items are aligned one in front of the other having a neat edge for rows of items. The tool 10 can save the operator considerable amount of time in the blocking operation.

In examples, the elongated rod 12 is composed of a metallic rod which is sturdy and rigid but also pliable such that the grip portion 16 can be pre-formed directly from the rod 12. Depending upon the anticipated use, it may be advantageous that the rod 12 be constructed of material such that the protrusion 18 and/or the hook 17a can be manually bent by an operator to an expanded, more open mode, or a contracted, more close mode to suit the particular needs and desires of the operator.

Although not shown, the blocking tool 10 may be provided with a magnet on a portion thereof, such as on the loop portion 17, for magnetically attaching the tool 10 to a shelf, for storage or temporary storage thereof. And, still further, preferably, all components of the blocking tool 10 are coplanar such that the elongated rod 12, the grabbing end 14, the loop 17, and the protrusion 18 all are disposed in the same vertical plane, such as shown in FIG. 3.

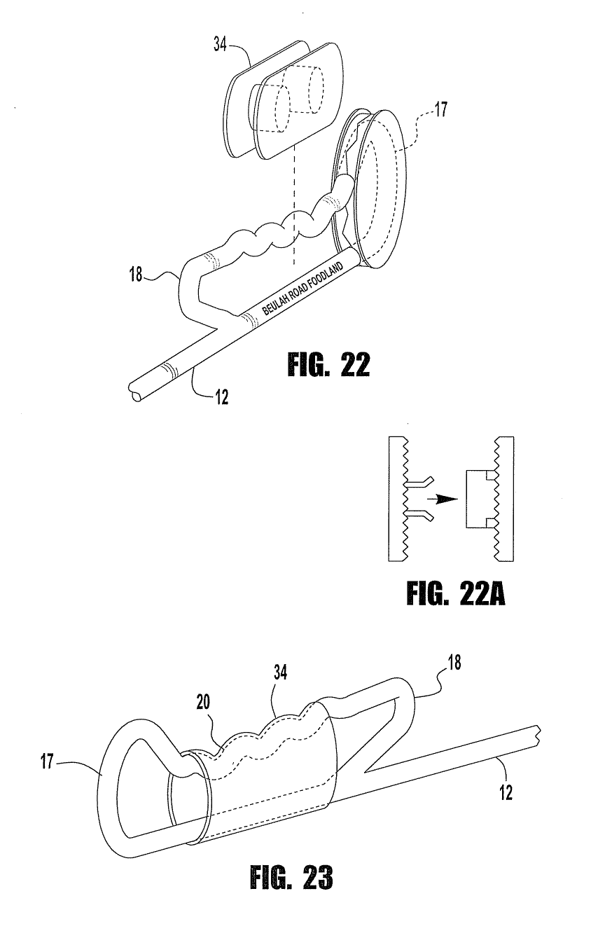

In embodiments of the invention, an insert 34 is included in the grip portion 16 of tool 10, such as shown for example in FIG. 21. The insert 34 can be a key-ring, a double map-lock insert, a slide-in molded plastic insert or a rubberized sheath as in FIGS. 21-23, respectively. As in FIG. 21, a side view of which is shown in FIG. 21A, a snap lock 34 can be positioned at the peak between undulations 20. It can be a larger unit that is thick enough to support the tension spring effect. Another variation can be as shown in FIG. 22. Further, insert 34 can be of flexible material such as shown for example in FIG. 23. In this example, insert 34 is an elastic-type material that follows the contour of the grip. Optionally it can be pulled on by the user. In other aspects of the invention insert 34 and grip 16 fit together to resemble and/or take the form of an arbitrary shape, such as a pitcher, ketchup bottle, car, etc. Optionally, the insert 34 is removable. Insert 34 may have an inscription or imprint on the front and/or rear faces thereof. For instance, the face of insert 34 may be used for marketing purposes. A trademark can be imprint or engraved on insert 34 to identify the origin of goods, or, alternatively, in an example, this insert 34 can carry the name of the grocery store or like that purchased the product.

It should be understood that the principles of the subject invention are not limited to any particular dimensional size or materials of construction, and furthermore, is not limited to the particular shape of the panel grip or limited to the embodiments shown for illustration. It should also be understood by those skilled in the art that various modifications can be made to this new and unique blocking tool structure while still falling within the purview of the overall principals of the subject invention.

What is claimed is:

1. A device for aligning objects comprising an elongated body having a grabbing end and a grip portion at an opposite end, wherein the grabbing end forms a bent arm extending from the body and terminating with a short nub; and wherein the grip portion forms a loop with at least one curvature, and a protrusion being generally intermediate the loop and the grabbing end.

2. The device of claim 1, wherein the body is a rod shaped like a tube, cylinder or elongated cube.

3. The device of claim 1, wherein the body comprises a material selected from the group consisting of metals, metallic alloys, non-metallic alloys, plastics, composites, and a combination thereof.

4. The device of claim 1, wherein the arm extends from the body at an angle α that is between about 45° and about 100°.

5. The device of claim 1, wherein the nub is inclined at an angle β relative to a vertical plane that passes though the arm.

6. The device of claim 1, wherein angle β is an acute angle.

7. The device of claim 1, wherein angle β is zero.

8. The device of claim 1, wherein the nub terminates with an end that is flat, tapered, pointed or beveled.

9. The device of claim 1, further including a cap having a hollow end designed to fit over the end of the nub.

10. The device of claim 1, wherein the arm has a length in the range of about 3 cm to about 12 cm, and the nub has a length in the range of about 1 cm to 4 cm.

11. The device of claim 1, wherein the grip portion has more than one curvature formed directly in the body creating a grip positioned to fit a user's fingers.

12. The device of claim 1, wherein the loop has curvatures formed on the outer surface of a portion of the loop

13. The device of claim 1, wherein the protrusion extends from the elongated body toward the grabbing end at an acute angle.

14. The device of claim 1, wherein the protrusion is formed from a loop in the body intermediate the grabbing end and the grip portion.

15. The device of claim 1, and further comprising a magnet positioned thereon.

16. The device of claim 1, and further comprising an insert removably attached to the grip portion.

17. A device comprising an elongated body having a grabbing end and a grip end, wherein the grabbing end forms a bent arm extending from the body and terminating with a short nub; and wherein the grip end forms a loop with at least one curvature generally positioned in the same plane as the arm, and a protrusion in the body between the loop and the grabbing end.

18. The device of claim 17, wherein the protrusion and loop are integrally formed from a continuous part of grip portion.

19. The device of claim 17, wherein the protrusion is expanded or compressed.
